(19) United States
(12) Patent Application Publication
(10) Pub. No.: US 2008/0065602 A1
(43) Pub. Date: Mar. 13, 2008

(54) SELECTING ADVERTISEMENTS FOR SEARCH RESULTS

(76) Inventors: Brian John Cragun, Rochester, MN (US); Paul Reuben Day, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/530,941

(22) Filed: Sep. 12, 2006

(51) Int. Cl. G06F 17/30

(52) U.S. Cl. 707/3

(57) ABSTRACT

In response to a search request that specifies a search keyword, search results are created that include identifiers of pages. An advertisement is selected that has the largest number of associated target terms that match selected words contained in the pages, where at least one of the selected words is different from the search keyword. The advertisement is then embedded into the search results and the search results are sent to an application that provided the search request. In an embodiment, the advertisement is selected that has the largest number of associated target terms that match the selected words that have the largest aggregated weights, where the weights represent a relative importance of the selected word with respect to other words in the page.

### FIELD

An embodiment of the invention generally relates to computer systems and more specifically relates to selecting advertisements for search results pages.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Years ago, computers were isolated devices that did not communicate with each other. But, today computers are often connected in networks, such as the Internet or World Wide Web, and a user at one computer, often called a client, may wish to access information at multiple other computers, often called servers, via a network. Information is often stored at servers and sent to the clients in units of pages.

Many providers of the information content in the pages provide the pages to clients for free and earn money by selling advertisements to advertisers; the advertisements are then embedded in the pages. Advertisers have the goal of targeting their advertisements to the consumers who are most likely to want the products or services promoted by the advertisements.

One technique for targeting advertisements is used by websites that provide a search function that searches for pages that contain keywords entered by a user. These keywords indicate information that is of interest to the user, so the keywords are used to select advertisements that are targeted to the interest of the user. The problem with this technique is that the keywords entered by a user are often only an approximation of a more complex idea for which the user is attempting to search.

Another technique selects advertisements based on words that are present in the page that the user is currently viewing. This technique assumes that information in a page that the user is viewing is of interest to the user. The problem with this technique is that the user may not actually be interested in the currently displayed page, but is only viewing it to determine its relevancy (or lack thereof) and may ultimately exclude it as being irrelevant.

Thus, a better technique is needed for selecting advertisements targeted to the interests of the consumer.

### SUMMARY

A method, apparatus, system, and signal-bearing medium are provided. In an embodiment, in response to a search request that specifies a search keyword, search results are created that include identifiers of pages. An advertisement is selected that has the largest number of associated target terms that match selected words contained in the pages, where at least one of the selected words is different from the search keyword. The advertisement is then embedded into the search results and the search results are sent to an application that provided the search request. In an embodiment, the advertisement is selected that has the largest number of associated target terms that match the selected words that have the largest aggregated weights, where the weights represent a relative importance of the selected word with respect to other words in the page. The aggregated weights are calculated by a sum of weights for the selected word in the pages. In various embodiments, the selected words are chosen that have weights that are greater than a threshold or based on a selection criteria specified in a user profile. In this way, advertisements may be selected that better target the interests of the consumer.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example user interface for search results, according to an embodiment of the invention.

FIG. 3 depicts a block diagram of source for an example page, according to an embodiment of the invention.

FIG. 4 depicts a block diagram of an example displayed page, according to an embodiment of the invention.

FIG. 5 depicts a block diagram of an example data structure for an example index, according to an embodiment of the invention.

FIG. 6 depicts a block diagram of an example user profile, according to an embodiment of the invention.

FIG. 7 depicts a block diagram of example advertisement data, according to an embodiment of the invention.

FIG. 8 depicts a flowchart of example processing for crawling pages, according to an embodiment of the invention.

FIG. 9 depicts a flowchart of example processing for a search engine, according to an embodiment of the invention.

FIG. 10 depicts a flowchart of example processing for creating search results, according to an embodiment of the invention.

FIG. 11 depicts a flowchart of example processing for handling search results, according to an embodiment of the invention.

FIG. 12 depicts a flowchart of example processing for selecting an advertisement based on links in a page, according to an embodiment of the invention.

FIG. 13 depicts a flowchart of example processing for adding words to a pool, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment of the invention, a search engine receives a search request from an application. The search request includes a search keyword or keywords. The search engine finds pages (via an index) that contain terms that match (are identical to) the keyword(s) and creates search results that includes identifiers of the pages. The identifiers may include, e.g., titles of the pages, addresses of the pages such as URLs (Uniform Resource Locators), and abstracts. The search engine also selects an advertisement and embeds the advertisement into the search results and then sends the search results to the application that provided the search request. The search engine selects the advertisement based on words in the pages and an aggregation of weights for those words. The words in the pages that the search engine uses to select the advertisement may be any words and are not restricted to terms that match the search keywords, and at least one of the words used to select the advertisement is different from the search keywords. A word's weight for a page represents the significance or importance of the word in that page relative to other words in that page. The aggregation of the weights for a particular word is the sum of the weights for the word in the different pages that the word appears. Since the same word in different pages may have a different importance or significance in the different pages, a word may have a different weight in different pages, depending, e.g., on the location or frequency of the word in the particular page. In an embodiment, the words and the weights are stored in the index, so the search engine does not necessarily need to retrieve the pages in order to create the search results. The search engine may also aggregate the weights over multiple search requests that provide some of the same keywords or different search keywords.

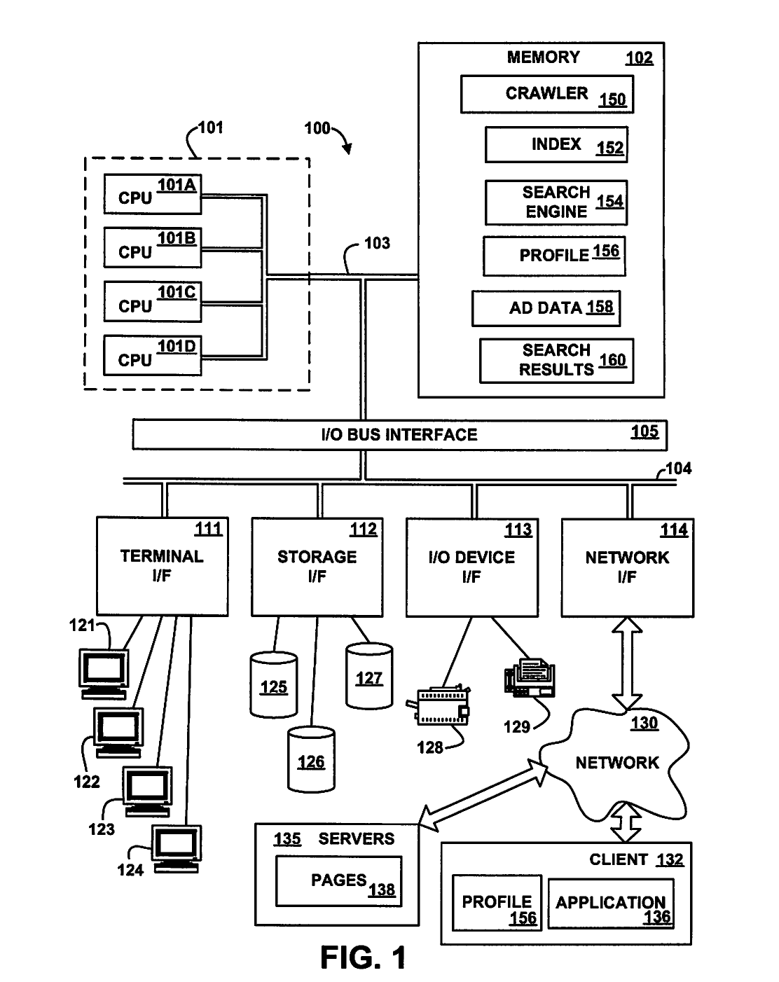

Referring to the Drawings, wherein like numbers denote like parts throughout the several views, FIG. 1 depicts a high-level block diagram representation of a computer system 100 connected to a client computer system 132 and server computer systems 135 via a network 130, according to an embodiment of the present invention. The terms “client” and “server” are used herein for convenience only, and in various embodiments a computer that operates as a client in one environment may operate as a server in another environment, and vice versa. In an embodiment, the hardware components of the computer systems 100, 132, and 135 may be implemented by a System i™ integrated business system available from International Business Machines Corporation of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a crawler 150, an index 152, a search engine 154, a user profile 156, advertisement data 158, and search results 160. Although the crawler 150, the index 152, the search engine 154, the user profile 156, the advertisement data 158, and the search results 160 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the crawler 150, the index 152, the search engine 154, the user profile 156, the advertisement data 158, and the search results 160 are illustrated as being contained within the main memory 102, these elements are not necessarily all completely contained in the same storage device at the same time. Further, although the crawler 150, the index 152, the search engine 154, the user profile 156, the advertisement data 158, and the search results 160 are illustrated as being separate entities, in other embodiments some of them, portions of some of them, or all of them may be packaged together.

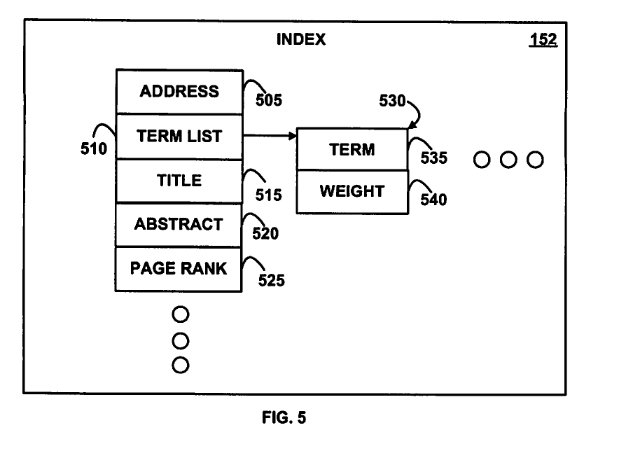

The crawler 150 (also called a also called a spider, robot, or agent) visits a page at the server 135, reads it, and then follows links to other pages within the web site. The crawler 150 typically returns to the site on a regular basis, such as every month or two, to look for changes. The crawler 150 stores selected information it finds in the index 152, which represents the pages 138 at the servers 135. The index 152 is further described below with reference to FIG. 5. Sometimes new pages or changes that the crawler 150 finds may take some time to be added to the index 152. Thus, a web page may have been “crawled” but not yet “indexed.” Until the page has been added to the index 152, the page is not available to those searching with the search engine 154. The search engine 154 interrogates the many pages 138 recorded in the pre-created index 152 to find matches to search keywords received from the clients 132 and ranks the pages 138 in order of what the program believes is most popular, which is often referred to as the page rank. Page rank is important to the user because a simple search request using common keywords may match thousands or even tens of thousands of the pages 135, which would be virtually impossible for the user to individually sort through in an attempt to determine which pages best serves the user's needs. The search engine 154 further creates the search results 160, which identifies the found pages, selects an advertisement from the advertisement data 158 for the search results 160 based on the user profile 156, and sends the search results 160 to the client 132 that provided the search request.

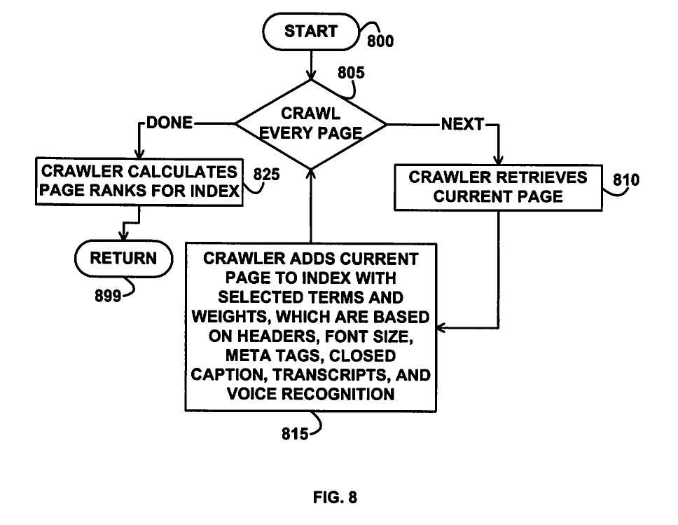

In an embodiment, the search engine 154 includes instructions capable of executing on the processor 101 or statements capable of being interpreted by instructions executing on the processor 101 to perform the functions as further described below with reference to FIGS. 8, 9, 10, 11, 12, and 13. In another embodiment, the search engine 154 may be implemented in microcode. In another embodiment, the search engine 154 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

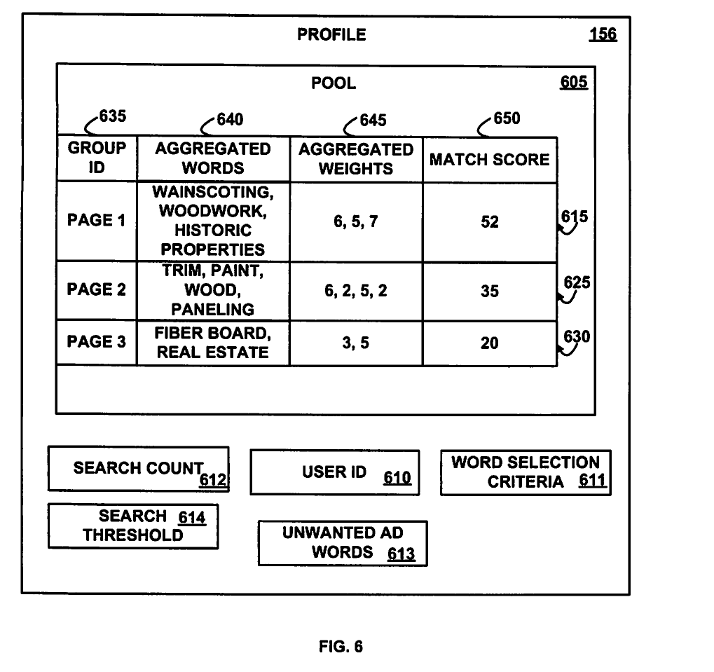

The client 132 may include some or all of the hardware components previously described above as being included in the computer system 100. The client 132 includes an application 136 and a user profile 156, both of which may be encoded in a memory with a description similar to the main memory 102. The application 136 sends search requests with search keywords to the search engine 154. In an embodiment, the application 136 may be implemented via a browser, but in other embodiments the application 136 may be an operating system, a user application, a third-party application, or any appropriate program encoded with executable instructions or interpretable statements for execution on a processor similar to the processor 101. In another embodiment, the application 136 may implemented in hardware. The user profile 156 is further described below with reference to FIG. 6.

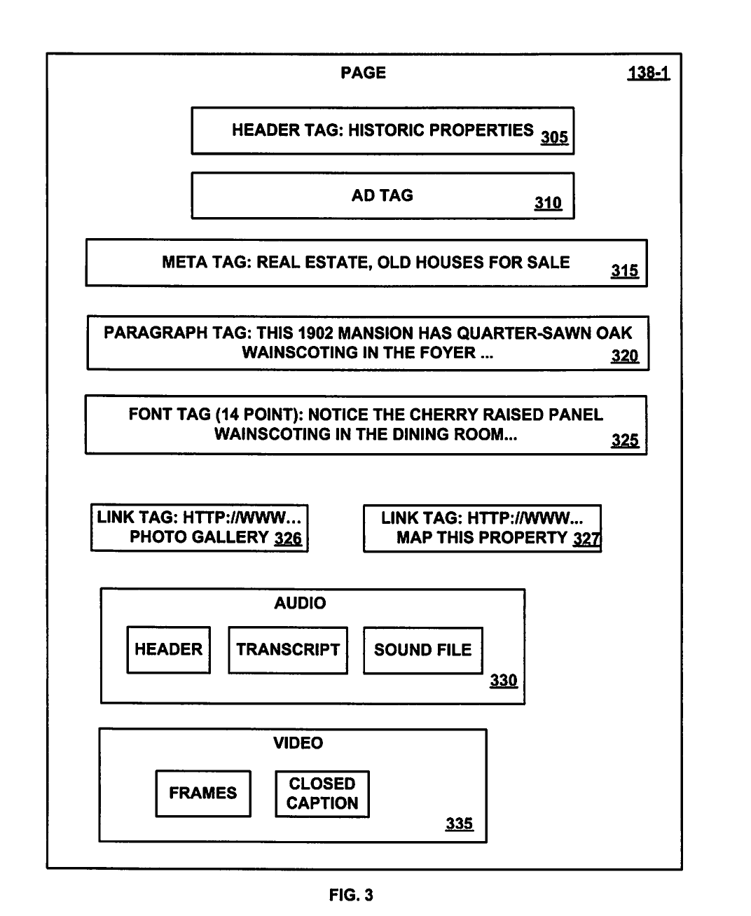

The servers 135 may include some or all of the hardware components previously described above as being included in the computer system 100. The servers 135 include pages 138 stored in memory with a similar description as the main memory 102. The pages 138 may include any appropriate content that is capable of being crawled via the crawler 150 and retrieved via the application 136. In various embodiments, the pages 138 may be implemented via documents, files, objects, tables, databases, directories, subdirectories, or any portion or combination thereof and in some embodiments may include embedded control tags, statements, or logic in addition to data. An example of the page 138 is further described below with reference to FIG. 3.

It should be understood that FIG. 1 is intended to depict the representative major components of the computer system 100, the network 130, the client computer system 132, and the server computer systems 135 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100 and/or the client computer system 132, and that, when read and executed by one or more processors in the server computer system 100 and/or the client computer system 132, cause the server computer system 100 and/or the client computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server computer system 100 and/or the client computer system 132 via a variety of tangible signal-bearing media that may be operatively or communicatively connected (directly or indirectly) to the processor or processors, such as the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102, CD-RW, or diskette; or

(3) information conveyed to the computer system 100 and/or the client computer system 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

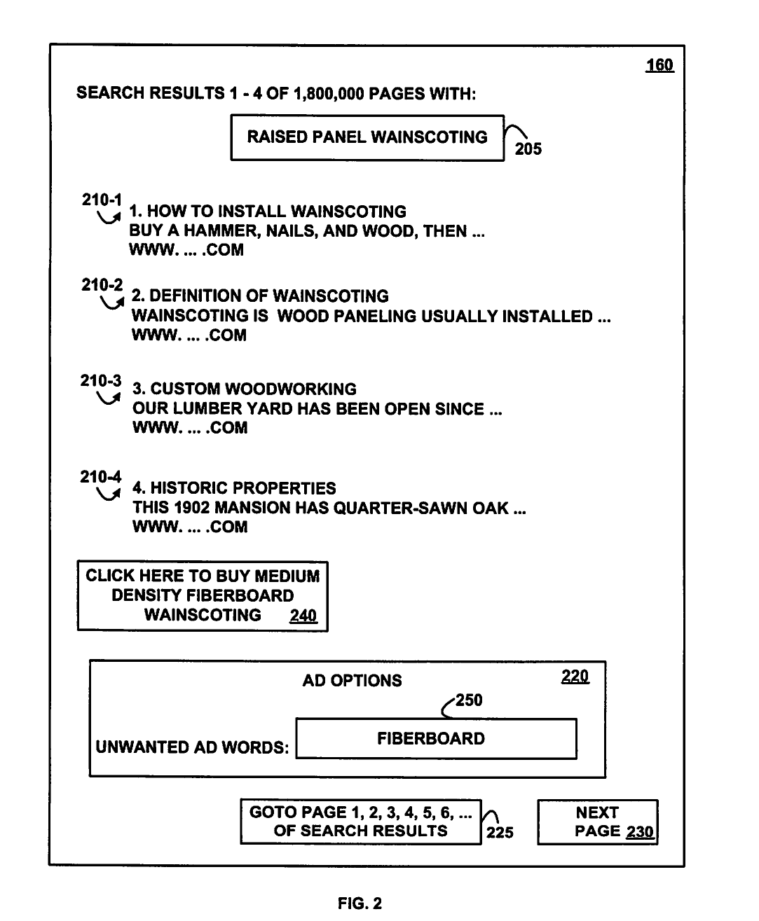

FIG. 2 depicts a block diagram of an example user interface for the search results 160, according to an embodiment of the invention. The search results 160 is a page that the search engine 154 creates and sends to the application 136 for display on a display terminal analogous to the terminals 121, 122, 123, or 124. The search results 160 includes search keywords 205, identifiers 210-1, 210-2, 210-3, and 210-4, an advertisement 240, advertisement options 220, a goto button 225, and a next page button 230. The search keywords 205 illustrate example search keywords received from the application 136 as part of a search request. In response to receiving the search request with the search keywords 205, the search engine 154 searched the index 152 and found some pages 138 represented in the index 152 that contain the search keywords 205. In an embodiment, the search engine 154 does not necessarily, but may, retrieve the pages 138 from the servers 135, and the found pages need not reside on the same server 135. The identifiers 210-1, 210-2, 210-3, and 210-4 identify four of the pages that the search engine 154 found represented in the index 152. In the example search results page 160 illustrated in FIG. 2, the identifiers 210-1, 210-2, 210-3, and 210-4 include a title of the respective found page, an abstract of the respective found page, and an address (e.g., a URL) of the respective found page, but in other embodiments any appropriate information regarding the found page may be displayed. Although some of the found pages are identified in the search results 160, the found pages themselves are not a part of the search results 160.

The advertisement 240 is information in the form of video, audio, images, and/or text that promotes or attempts to sell goods, services, and/or information or attempts to encourage or solicit a consumer or viewer of the advertisement at the client 132 to retrieve another page that promotes or attempts to sell goods, services and/or information. For example, the advertisement 240 may have an associated address embedded in the search results page 160 that links to another page, which the user may retrieve via selecting the advertisement. In another embodiment, the advertisement 240 may be a public service, charitable promotion, or educational message.

The advertisement options 220 includes an unwanted ad words field 250, in which users may enter words that they do not want used to select the advertisement 240. As the number of found pages that contain the search keywords 205 may exceed the amount of space conveniently available for identifiers on a single search results page, the search results page 160 includes the goto button 225 and the next page button 230. The goto button 225 when selected requests the search engine 154 to send another specified page of the search results. The next page button 230 when selected requests the search engine 154 to send the next page of the search results.

FIG. 3 depicts a block diagram of source for an example page 138-1, according to an embodiment of the invention. The page 138-1 is an example of the page 138. The crawler 150 found the page 138-1 and created an entry for the page 138-1 in the index 152. The search engine 154 found the entry for the page 138-1 in the index 152 in response to receiving the search request and search keywords 205 and created the identifier 210-4 for the found page 138-1 in the search results page 160 (FIG. 2). The application 136 retrieves the page 138-1 associated with the identifier 210-4 in response to selection of the address portion of the identifier 210-4 via a user interface at the client 132. The example page 138-1 includes a header tag 305, an advertisement tag 310, a meta tag 315, a paragraph tag 320, a font tag 325, link tags 326 and 327, an audio tag 330, and a video tag 335. The video 335 may include both video images and audio sounds. The page 138-1 may be searched and advertisements may be selected for the page based on words included as text in the page or based on words extracted from transcripts, closed caption data, and sound files via speech recognition.

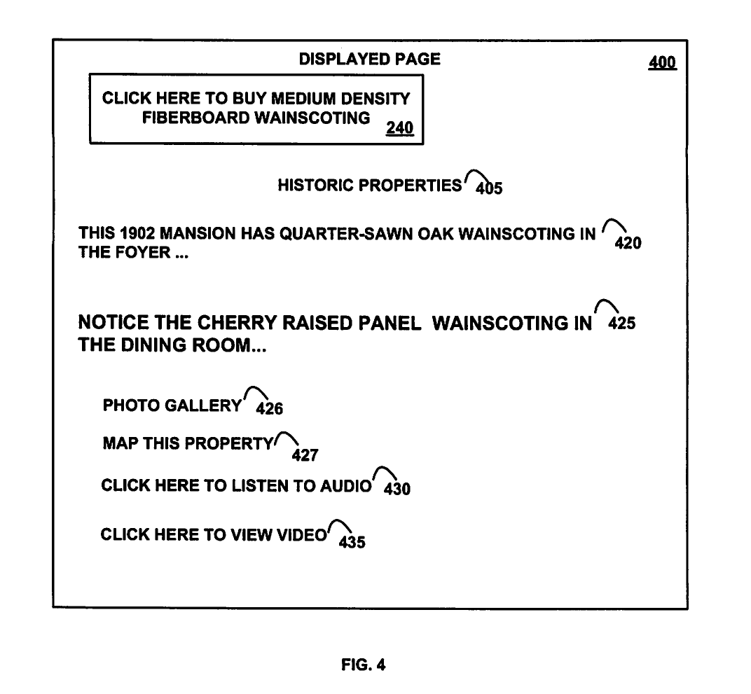

FIG. 4 depicts a block diagram of a user interface for an example displayed page 400, according to an embodiment of the invention. The application 136 displays the displayed page 400 on a terminal analogous to the terminals 121, 122, 123, or 124 by rendering and interpreting the tags and data in the page 138-1. The displayed page 400 includes an advertisement 240, a header 405, paragraph 420, text with a different font 425, links 426 and 427, an audio link 430, and a video link 435. The application 136 displays the advertisement 240 in response to the advertisement tag 310 (FIG. 3); displays the header 405 in response to the header tag 305; displays the paragraph 420 in response to the paragraph tag 320; displays the text with a different font 425 in response to the font tag 325; displays the link 426 in response to the link tag 326; displays the link 427 in response to the link tag 327; displays the audio link 430 in response to the audio tag 330; and displays the video link 435 in response to the video tag 335.

FIG. 5 depicts a block diagram of an example data structure for an example index 152, according to an embodiment of the invention. The crawler 150 creates the index 152, as further described below with reference to FIG. 8. The index 152 includes an address 505, a term list 510, a title 515, an abstract 520, and a page rank 525 for each page 138. The address 505 includes the URL (Uniform Resource Locator) or other address of the page 138 at the server 135. The term list 510 includes a list of term entries 530 for each term in the page 138. Each term entry 530 includes a term 535 and a term weight 540. The term 535 includes a word or collections of words in the page 138. The weight 540 indicates the relative weight, significance, or importance of the associated term 535, as compared to other terms 535 in the term list 530, which represent other words in the page identified by the address 505.

The crawler 150 may determine the weight 540 based on the location on the page (pointed to by the address 505) of the weight's associated term 535 and/or the frequency that the associated term 535 appears on the page 138. For example, the crawler 150 may assign a higher weight to terms that appear in a title or header tag (e.g., the header tag 305 of FIG. 3) because the crawler 150 assumes that terms in the title or header are more relevant than terms appearing in other locations in the page. Further, the crawler 150 may also assign a higher weight to terms that appear near the top of the page, such as in the headline or in the first few paragraphs (e.g., the paragraph 320 of FIG. 3) of text because the crawler 150 assumes that any page relevant to the topic will mention those words at the beginning. Further, the crawler 150 may also assign a higher weight to terms that appear in a larger font size (e.g., the larger font size as indicated in the font tag 325 of FIG. 3) than terms that appear in a smaller font size because the crawler 150 assumes that terms displayed in a larger font are more important than terms displayed in a smaller font. The crawler 150 may also assign a higher weight to terms that appear in a meta tag, e.g., the meta tag 315. The crawler 150 may also analyze how often terms appear in relation to other words in the web page and assign a higher weight to those terms 535 that appear more frequently.

The title 515 and the abstract 520 may be any text, audio (e.g., in the audio 330 of FIG. 3), video (e.g., in the video 335 of FIG. 3), or image that describe the page at the associated address 505. The page rank 525 indicates a relative importance of the page 138 at the address 505, as compared to other of the pages 138 in the index 152.

FIG. 6 depicts a block diagram of an example user profile 156, according to an embodiment of the invention. The user profile 156 includes a pool 605, a user identifier 610, a word selection criteria 611, a search count 612, unwanted ad words 613, and a search threshold 614. The pool 605 includes example records 615, 625, and 630, each of which includes a group identifier 635, aggregated words 640, aggregated weights 645, and a match score 650. The group identifier 635 identifies each record and may serve to divide the aggregated words 640 into pages of search results. The aggregated words 640 includes a collection of words that have appeared in pages 138 found by searches initiated by the user 610 via the application 136. The aggregated words 640 may be different from the search keywords 205 or may include some or all of the search keywords 205. The aggregated weights 645 indicate the sum of the individual weights 540 of the words for the various pages in which the aggregated words 640 appear.

The match score 650 indicates the relative degree to which the page in which the aggregated words 640 occur matches the search keywords 205 submitted by the application 136 associated with the user 610. The user identifier 610 identifies a user that uses and interacts with the application 136. The word selection criteria 611 indicates a technique that the search engine 154 is to use when selecting the aggregated words 640. In various embodiments, the word selection criteria 611 may indicate selecting words from the pages 138 whose weight exceeds a weight threshold, selecting words from the abstract and title portion of the page 138, or selecting words that match the search keywords 138. In various embodiments, the word selection criteria 611 may be set by the user 610, by the application 136, or by the search engine 154.

The search count 612 indicates a number of times that the user 610 has requested a search via the application 136 since the last time the search count 612 was reset to zero. The unwanted ad words 613 indicates word(s) that the user 610 does not want used to select advertisements, and may be set from a user interface selection of the unwanted ad words 250. The search threshold 614 indicates a number of searches, which when reached by the search count 612 causes the records in the pool 605 to be deleted and the search count 612 to be reset to zero. In various embodiments, the search threshold 614 may be set by the user, by the application 136, or by the search engine 154.

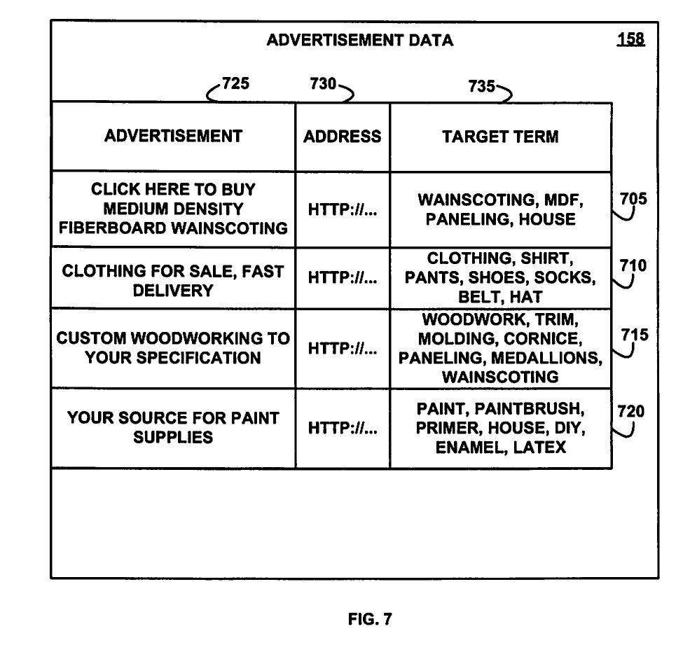

FIG. 7 depicts a block diagram of example advertisement data 158, according to an embodiment of the invention. The search engine 154 uses the advertisement data 158 to select an advertisement for inclusion in the search results or in a page 138. The advertisement data 158 includes records 705, 710, 715, and 720, each of which includes an advertisement field 725, an address field 730, and a target term field 735. The advertisement field 725 includes or identifies the location of an advertisement. The address field 730 identifies an address (e.g., a URL) of an associated page on one of the servers 135 that the application 136 is to retrieve if the advertisement 725 is embedded in a page or search results that is displayed at the client 132 and if the advertisement 725 is selected by a user viewing the advertisement.

The target term field 735 includes words that are associated with their respective advertisements 725. The search engine 154 uses the target terms 735 to target the advertisement 725 to an audience likely to be interested in the goods, services, or cause promoted by the advertisement 725. The target terms 735 may be terms found in the advertisement 725 or terms related to the goods, services, or cause of the advertisement 725. In various embodiments, the target terms 735 may be selected by the advertiser, a provider of the advertisement, or by the search engine 154.

FIG. 8 depicts a flowchart of example processing for crawling the pages 138, according to an embodiment of the invention. The processing of FIG. 8 is performed periodically, so that the crawler 150 may crawl and process any pages 138 that have been added or modified since the last time that the crawler 150 crawled the pages 138.

Control begins at block 800. Control then continues to block 805 where the crawler 150 enters a loop that is executed once for each page 138. The crawler 150 may crawl all pages 138 or a subset of the pages 138. So long as more pages 138 remain to be crawled, control continues from block 805 to block 810 where the crawler 150 retrieves the current page 138 from a server 135.

Control then continues to block 815 where the crawler 150 adds the current page 138 to the index 152. Adding the current page 138 to the index 152 includes storing the address for the current page 138 in the address 505, selecting and storing the terms that exist in the current page 138 into the terms 535 of the index 152, and calculating and storing the weights for the selected terms in the index 152.

The crawler 150 may use any appropriate technique for selecting the terms 535 and the weights 540. For example, in an embodiment the crawler 150 may choose to ignore short, common words in the page 138 (e.g., “a” “and,” and “the”), and not store these words in the terms 535. In an embodiment, the crawler 150 may select the weights 540 based on the location and/or frequency of the selected terms 535 in the current page 138. For example, the crawler 150 may assign higher weights 540 to those selected terms 535 that are in the title portion of the page 138 and assign lower weights 540 to those terms 535 that are at the bottom of the page 138. In an embodiment, the crawler 150 may assign higher weights 540 to those terms 535 that are used more frequently in the page 138 while assigning lower weights 540 to those terms 535 that are used less frequently in the page 138. In an embodiment, the crawler 150 may assign higher weights 540 to those terms 535 that have a larger font size in the page 138 while assigning lower weights 540 to those terms 535 that have a smaller font size in the page 138. In an embodiment, the crawler 150 may assign higher weights 540 to those terms 535 that are within meta tags while assigning lower weights 540 to those terms 535 that are not within meta tags in the page 138. In various embodiments, the crawler 150 may find terms in the page 138 via closed caption tags, transcripts, and voice recognition techniques for analyzing audio or audio with video. But, in other embodiments, the crawler 150 may used any appropriate technique for selecting the terms from the page 138 to store in the terms 535 and for selecting the weights 540 for those terms 535.

Control then returns to block 805 where the crawler 150 determines whether another page 138 still exists to be crawled, as previously described above.

If the crawler 150 has crawled every page 138 or every page in a subset of the pages 138, then control continues from block 805 to block 825 where the crawler 150 calculates the page ranks 525 for every page 138 in the index 152. In an embodiment, the crawler 150 may use either or both of on-the-page criteria or off-the-page criteria to determine the page ranks 525. On-the-page ranking criteria may include the relative weights 540 of the terms 535. Off-the-page ranking criteria use data external to the page itself. An example of an off-the-page ranking criteria is link analysis, in which the crawler 150 analyzes how pages link to each other to determine the relative importance of the page with respect to other pages. For example, the crawler 150 may assign a higher page rank to a page to which many other pages link because such a page is probably an important page. In addition, the crawler 150 may use recursive page-ranking where the page rank of the pages that link to the linked-to page also factor into the ranking of the linked-to page. A link is an address of a linked page that is embedded in a linking page that, when selected, causes the linked page to be retrieved. A URL (Uniform Resource Locator) is an example of a link, but in other embodiments any appropriate link may be used.

Control then continues to block 899 where the logic of FIG. 8 returns.

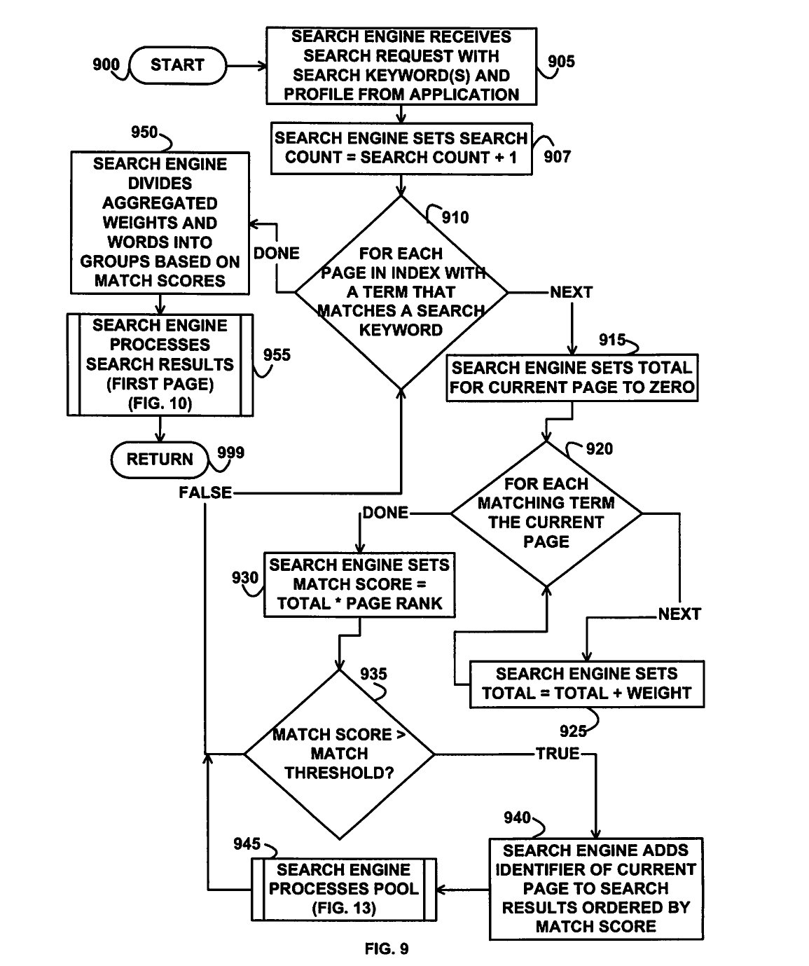

FIG. 9 depicts a flowchart of example processing for the search engine 154, according to an embodiment of the invention. Control then continues to block 905 where the search engine 154 receives a search request with at least one search keyword and the user profile 156 from the application 136 at the client 132. In another embodiment, the user profile 156 is stored for registered users at the computer system 100, and the search engine 154 receives a user identifier from the application 136 and finds the user profile 156 associated with the user identifier at the computer system 100. Control then continues to block 907 where the search engine 154 increments the search count 612 by one, in order to count the number of search requests that the user has initiated or submitted. The search engine 154 keeps track of the number of search requests for the user in order to select the advertisement based on multiple search requests, by aggregating weights for words in the found pages across multiple searches.

Control then continues to block 910 where the search engine 154 enters a loop that executes once for each page 138 in the index 152 with a term 535 that matches (equals) one of the received search keywords. So long as a page 138 exists in the index 152 with a term 535 that matches a received search keyword, control continues from block 910 to block 915 where the search engine 154 sets a total for the current page 138 to zero.

Control then continues to block 920 where the search engine 154 enters a loop that executes once for each matching term 535 (that matches a received search keyword) in the current page 138. So long as a term 535 exists for the current page 138 that matches the received search keyword, control continues from block 920 to block 925 where the search engine 154 sets the total to be the total plus the weight 540 for the current matching term 535. Control then returns to block 920 where the search engine 154 sets the current matching term 535 to be the next matching term 535 in the current page 138 and determines whether all matching terms 535 in the current page 138 have been processed.

When all matching terms 535 for the current page 138 have been processed, the loop that starts at block 920 is done, so control continues from block 920 to block 930 where the search engine 154 sets the match score for the current page to be the total that was calculated by the loop that started at block 920 multiplied by the page rank 525 for the current page 138. Control then continues to block 935 where the search engine 154 determines whether the match score is greater than a match threshold.

If the determination at block 935 is true, then the match score is greater than a match threshold, so control continues from block 935 to block 940 where the search engine 154 adds an identifier of the current page 138 to the matching search results, ordered by the match score with the identifiers for the pages with the highest match scores at the top. For example, in FIG. 2, the page associated with the identifier 210-1 has a higher match score than the page associated with the identifier 210-2, which has a higher match score than the page associated with the identifier 210-3, which has a higher match score than the page associated with the identifier 210-4. Adding the identifier of the current page 138 to the matching search results may include adding some or all of the address 505, the title 515, the terms 535, and/or the abstract 520 as an identifier for the current page in the search results 160.

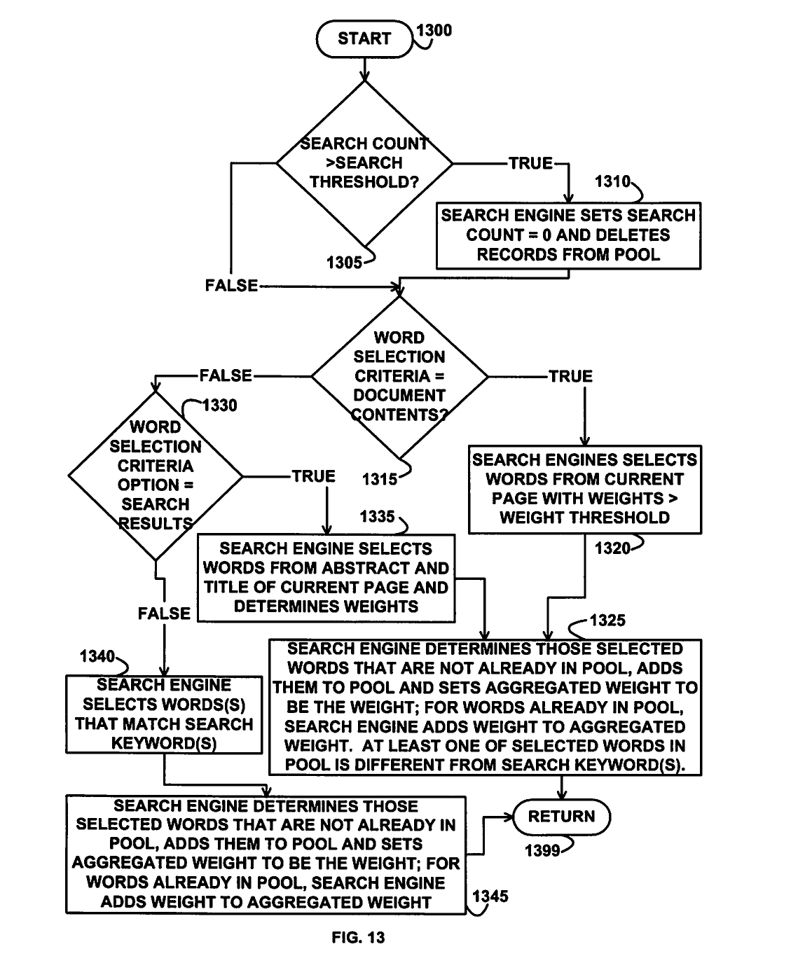

Control then continues to block 945 where the search engine 154 adds selected words from the current page to the pool 605, as further described below with reference to FIG. 13.

Control then returns to block 910 where the search engine 154 changes the current page 138 to be the next page 138 represented in the index 152 with a term 535 that matches a received search keyword, and determines whether all pages 138 with terms 535 that match a search keyword have been processed, as previously described above.

If the determination at block 935 is false, then the match score is not greater than the match threshold, so control returns from block 935 to block 910, as previously described above.

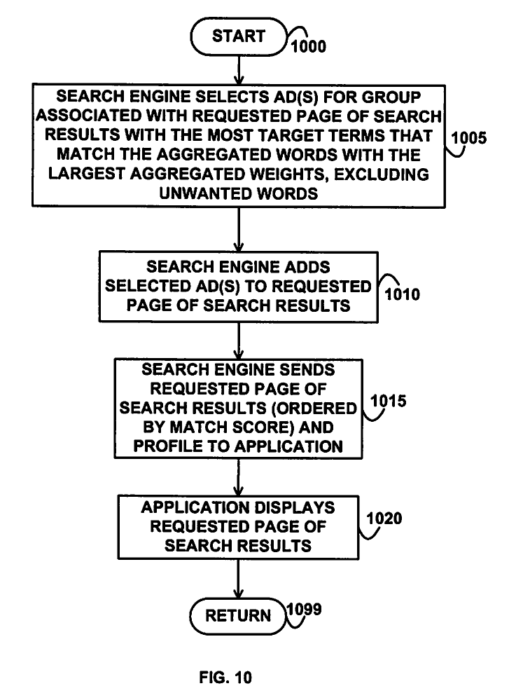

When all pages 138 in the index 152 with a term 535 that matches the received search keyword have been processed by the loop that starts at block 910, then the loop that starts at block 910 is done, so control continues from block 910 to block 950 where the search engine 154 divides the aggregated weights and words into groups based on the match scores and adds group identifiers 635 to the groups, representing pages of the search results. Control then continues to block 955 where the search engine 154 processes the search results for the first page of the search results, as further described below with reference to FIG. 10. Control then continues to block 999 where the logic of FIG. 9 returns.

FIG. 10 depicts a flowchart of example processing for creating search results 160, according to an embodiment of the invention. The logic of FIG. 10 receives a requested search result page as input. Control begins at block 1000. Control then continues to block 1005 where the search engine 154 selects advertisement(s) 725 for the group associated with the requested search results page. The search engine 154 selects the advertisement(s) 725 that have the most target terms 735 that match (are the same as) the aggregated words 640 in the user profile 156 with the largest aggregated weights 645. At least one of the aggregated words 640 is different from the search keywords submitted by the search request. The search engine 154 excludes advertisements 725 that have target terms 735 that match the unwanted ad words 613.

Control then continues to block 1010 where the search engine 154 adds the selected advertisement(s) 725 to the requested page of the search results 160 as the advertisement 240. Adding the selected advertisement 725 to the requested page may include embedding the address 730 of a page associated with the advertisement in to Control then continues to block 1015 where the search engine 154 sends the requested page of the search results (with the identifiers ordered by the match score) and the user profile 156 to the application 136. Control then continues to block 1020 where the search engine 154 displays the requested page of search results. Control then continues to block 1099 where the logic of FIG. 10 returns.

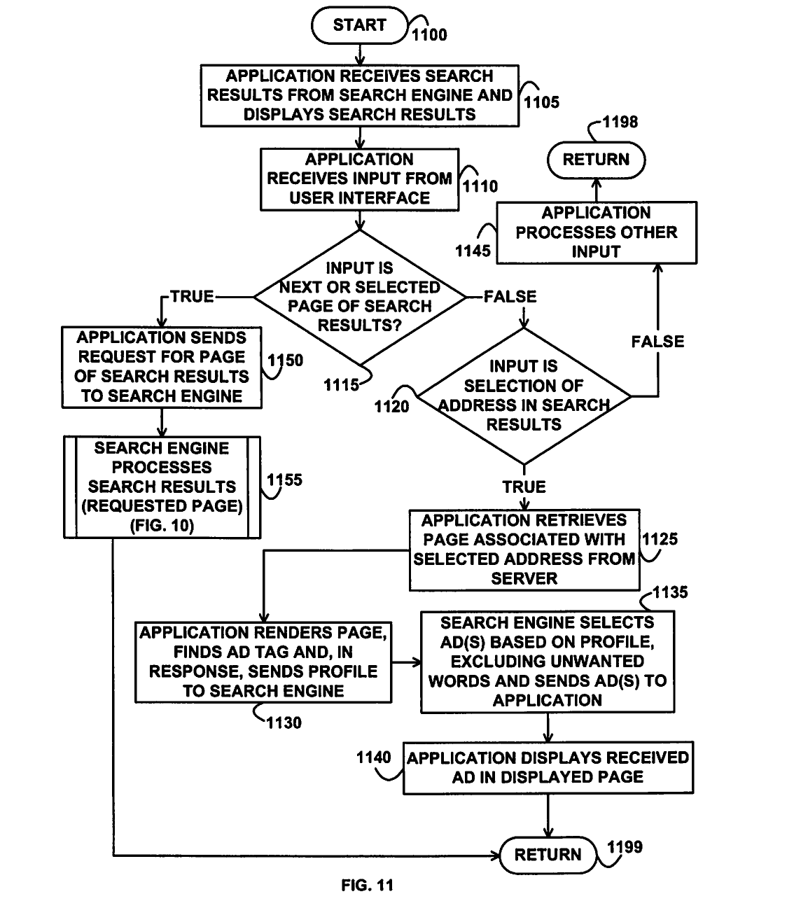

FIG. 11 depicts a flowchart of example processing for handling the search results 160, according to an embodiment of the invention. Control begins at block 1100. Control then continues to block 1105 where the application 136 receives the search results 160 from the search engine 154 and displays the search results 160. Control then continues to block 1110 where the application 136 receives an input selection from the user interface of the search results 160.

Control then continues to block 1115 where the application 136 determines whether the input is a request for the next page or a selected page of the search results. In an embodiment, the next page may be requested by selecting the next page button 230 of the user interface 160, and a selected page may be requested by selecting one of the page numbers in the goto page button 225 of the user interface 160. If the determination at block 1115 is true, then the input is a request for the next page or a selected page of the search results, so control continues to block 1150 where the application 136 sends a request for the next or selected page of the search results to the search engine 154. Control then continues to block 1155 where the search engine 154 processes the search results for the requested next or selected page, as previously described above with reference to FIG. 10. Control then continues to block 1199 where the logic of FIG. 11 returns.

If the determination at block 1115 is false, then the input is not a request for the next page or a selected page of the search results, so control continues to block 1120 where the application 136 determines whether the input is selection of the address portion of one of the identifiers in the search results 160. If the determination at block 1120 is true, then the input is selection of the address portion of one of the identifiers in the search results 160, so control continues to block 1125 where the application 136 retrieves the page at the selected address from the server. Control then continues to block 1130 where the application 136 renders the page and displays the page, finds the ad tag 310 in the page, and in response to the ad tag 310, sends the user profile 156 to the search engine 154, which receives the user profile 156.

Control then continues to block 1135 where the search engine 154 selects the advertisements with the most target terms 735 that match those aggregated words 640 in the pool 605 with the highest aggregated weights 645. The search engine 154 excludes the unwanted words from the target terms 735 while making the selection of the advertisements. The search engine further sends the selected advertisement(s) to the application 136. Control then continues to block 1140 where the application 136 displays the received advertisement in the displayed page. Control then continues to block 1199 where the logic of FIG. 11 returns.

If the determination at block 1120 is false, then the input is not a selection of the address portion of one of the identifiers in the search results 160, so control continues to block 1145 where the application 136 processes other input. Control then continues to block 1198 where the logic of FIG. 11 returns.

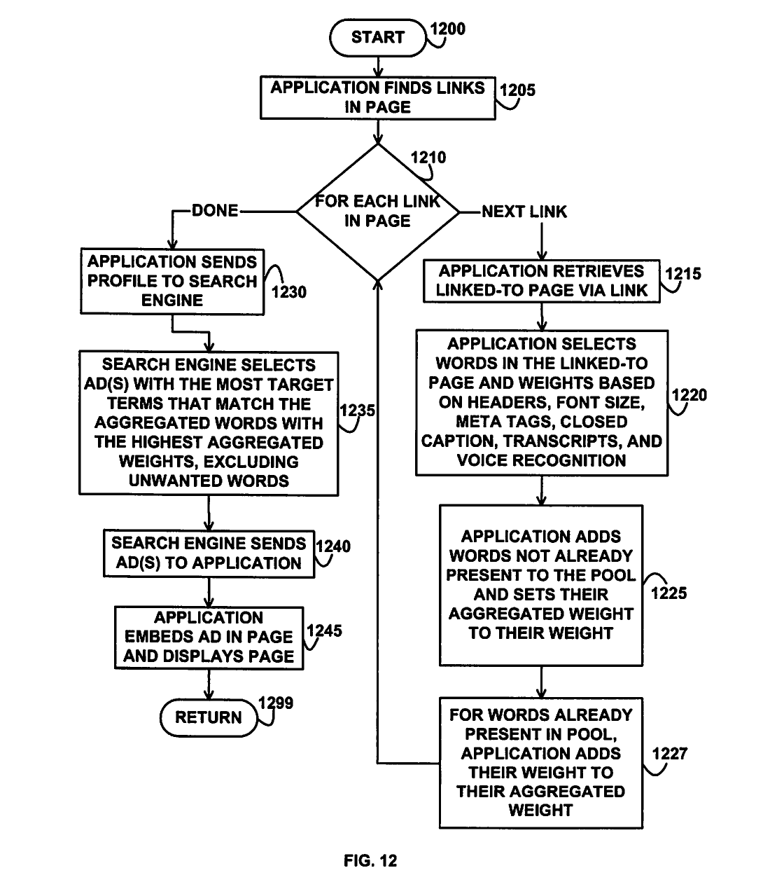

FIG. 12 depicts a flowchart of example processing for selecting an advertisement based on links in a page, according to an embodiment of the invention. Control begins at block 1200. Control then continues to block 1205 where the application 136 finds links in the page. Control then continues to block 1210 where the application 136 enters a loop that is executed once for each found link in the page. So long as a link exists in the page that remains unprocessed by the loop that starts at block 1210, control continues from block 1210 to block 1215 where the application 136 retrieves the linked-to page via the current link. The linked-to page is the page whose address exists as part of the current link.

Control then continues to block 1220 where the application 136 selects words in the linked-to page and weights for the words based on headers, titles, font size, meta tags, words that are in closed caption tags, and transcripts. The application 136 may further use voice recognition for finding words in audio data. In an embodiment, the application 136 may choose to ignore short, common words in the linked-to page (e.g., “a” “and,” and “the”). In an embodiment, the application 136 may select the weights based on the location and/or frequency of the selected words. For example, the application 136 may assign higher weights to those selected words that are in the title or header portion of the linked-to page and assign lower weights to those words that are at the bottom of the linked-to page. In an embodiment, the application 136 may assign higher weights to those words that are used more frequently in the linked-to page while assigning lower weights to those words that are used less frequently in the linked-to page. In an embodiment, the application 136 may assign higher weights to those words that have a larger font size in the linked-to page while assigning lower weights to those words that have a smaller font size in the linked-to page. In an embodiment, the application 136 may assign higher weights to those words that are within meta tags while assigning lower weights to those words that are not within meta tags in the linked-to page. In various embodiments, the application 136 may find words in the linked-to page via closed caption tags, transcripts, and voice recognition techniques for analyzing audio or audio that is a portion of, or embedded in, video. But, in other embodiments, the application 136 may used any appropriate technique for selecting the words and weights.

Control then continues to block 1225 where the application 136 adds words not already present in the pool 605 to the aggregated words 640 and sets the aggregated weights 645 for the added words to be the weights previously determined at block 1220. Control then continues to block 1227 where the application 136 adds the determined weight of the words to the aggregated weight for those words that are already present in the pool 605. Control then returns to block 1210 where the application 136 determines whether any unprocessed links remain in the page.

Once all links in the page have been processed by the loop that starts at block 1210, control continues from block 1210 to block 1230 where the application 136 sends the user profile 156 to the search engine 154. Control then continues to block 1235 where the search engine 154 selects the advertisements with the most target terms 735 that match those aggregated words 640 in the pool 605 with the highest aggregated weights 645. The search engine 154 excludes the unwanted words 613 from the target terms 735 while making the selection of the advertisements. Control then continues to block 1240 where the search engine 154 sends the selected advertisement(s) to the application 136. Control then continues to block 1245 where the application 136 receives and embeds the selected advertisement(s) in the page and displays the page. Control then continues to block 1299 where the logic of FIG. 12 returns.

FIG. 13 depicts a flowchart of example processing for adding words to the pool 605, according to an embodiment of the invention. Control begins at block 1300. Control then continues to block 1305 where the search engine 154 determines whether the search count 612 is greater than the search threshold 614. If the determination at block 1305 is true, then the search count 612 is greater than the search threshold 614, so control continues to block 1310 where the search engine 154 sets the search count 612 to zero and deletes all records from the pool 605. Control then continues to block 1315 where the search engine 154 determines whether the word selection criteria 611 requests using a word selection technique of selecting words whose weight exceeds a weight threshold.

If the determination at block 1315 is true, then the word selection criteria 611 requests using a word selection technique of selecting words whose weight exceeds a weight threshold, so control continues to block 1320 where the search engine 154 selects words from the current page whose weight exceeds a weight threshold. Control then continues to block 1325 where the search engine 154 determines those selected words that are not already in the pool 605, adds those determined selected words to the pool 605 and sets their aggregated weight to be their weights. The search engine 154 selects the words in the pool 605, so that at least one of the selected words is different from the search keywords. Control then continues to block 1399 where the logic of FIG. 13 returns.

If the determination at block 1315 is false, then the word selection criteria 611 does not request using a word selection technique of selecting words whose weight exceeds a weight threshold, so control continues to block 1330 where the search engine 154 determines whether the word selection criteria 611 requests using a word selection technique of selecting words from the abstract and title of the current page. If the determination at block 1330 is true, then the word selection criteria 611 requests using a word selection technique of selecting words from the abstract and title of the current page, so control continues to block 1335 where the search engine 154 selects words that are in the abstract and title of the current page. Control then continues to block 1325, as previously described above. Control then continues to block 1399 where the logic of FIG. 13 returns.

If the determination at block 1330 is false, then the word selection criteria 611 requests using a word selection technique of selecting words that match search keywords, so control continues to block 1340 where the search engine 154 selects selected words that match the search keyword(s). Control then continues to block 1345 where the search engine 154 determines those selected words that are not already in the pool 605, adds those determined selected words to the pool 605 and sets their aggregated weight to be their weights. Control then continues to block 1399 where the logic of FIG. 13 returns.

If the determination at block 1305 is false, then the search count 612 is not greater than the search threshold 614, so control continues to block 1315, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
in response to a search request that specifies a search keyword, creating a search results page that comprises a plurality of identifiers of a plurality of pages;
selecting a selected advertisement from among a plurality of advertisements that each have respective associated target terms, wherein the selecting chooses the selected advertisement with a largest number of the target terms that match selected words contained in the plurality of pages, wherein at least one of the selected words is different from the search keyword;
embedding the selected advertisement into the search results page; and
sending the search results page to an application that provided the search request.

2. The method of claim 1, wherein the selecting further comprises:
calculating a plurality of aggregated weights for the selected words, wherein each of the aggregated weights comprises a sum of a plurality of weights for the respective selected word in the plurality of pages; and
selecting the selected advertisement that has the largest number of associated target terms that match the selected words with largest aggregated weights.

3. The method of claim 2, wherein each of the plurality of weights represents a relative importance of the respective selected word in the respective page with respect to other words in the respective page.

4. The method of claim 2, wherein the selecting further comprises:
choosing the selected words that have the weights that are greater than a threshold.

5. The method of claim 1, wherein the selecting further chooses the selected advertisement with the largest number of the target terms that match the selected words contained in the plurality of pages and contained in a second plurality of pages found by a previous search request.

6. The method of claim 1 further comprising:
in response to a request for a second search results page for the search request, creating the second search results page that identifies a second plurality of respective pages, selecting a second selected advertisement with a largest number of the target terms that match selected words contained in the second plurality of pages, embedding the second selected advertisement into the second search results page, and sending the second search results page to the application.

7. A method for deploying computing services, comprising:
integrating computer readable code into a computer system, wherein the code in combination with the computer system performs the method of claim 1.

8. A signal-bearing medium encoded with instructions, wherein the instructions when executed comprise:
in response to a search request that specifies a search keyword, creating a search results page that comprises a plurality of identifiers of a plurality of pages, wherein each of the plurality of pages include the search keyword;
selecting a selected advertisement from among a plurality of advertisements that each have respective associated target terms, wherein the selecting chooses the selected advertisement with a largest number of the target terms that match selected words contained in the plurality of pages, wherein at least one of the selected words is different from the search keyword;
embedding the selected advertisement into the search results page; and
sending the search results page to an application that provided the search request.

9. The signal-bearing medium of claim 8, wherein the selecting further comprises:
calculating a plurality of aggregated weights for the selected words, wherein each of the aggregated weights comprises a sum of a plurality of weights for the respective selected word in the plurality of pages; and
selecting the selected advertisement that has a largest number of associated target terms that match the selected words with largest aggregated weights.

10. The signal-bearing medium of claim 9, wherein each of the plurality of weights represents a relative importance of the respective selected word in the respective page with respect to other words in the respective page.

11. The signal-bearing medium of claim 9, wherein the selecting further comprises:
choosing the selected words that have the weights that are greater than a threshold.

12. The signal-bearing medium of claim 8, wherein the selecting further comprises:
choosing the selected words that meet a selection criteria specified in a user profile associated with the search request.

13. The signal-bearing medium of claim 10, wherein the selecting further comprises:
selecting the selected advertisement that has a largest number of associated target terms that are not excluded as unwanted by a user profile and that match the selected words with largest aggregated weights.

14. The signal-bearing medium of claim 8, wherein the selecting further chooses the selected advertisement with the largest number of the target terms that match the selected words contained in the plurality of pages and contained in a second plurality of pages found by a previous search request.

15. The signal-bearing medium of claim 8, further comprising:
in response to a request for a second search results page for the search request, creating the second search results page that identifies a second plurality of respective pages, selecting a second selected advertisement with a largest number of the target terms that match selected words contained in the second plurality of pages, embedding the second selected advertisement into the second search results page, and sending the second search results page to the application.

16. The signal-bearing medium of claim 8, wherein the application retrieves one of the plurality of pages and embeds the selected advertisement into the one of the plurality of pages.

17. The signal-bearing medium of claim 8, wherein the application retrieves one of the plurality of pages and embeds a second advertisement into the one of the plurality of pages, wherein the application selects the second advertisement that has a largest number of the target terms that match selected words contained in linked-to pages that are linked to by the one of the plurality of pages.

18. A computer system comprising:
a processor; and
memory connected to the processor, wherein the memory encodes instructions that when executed by the processor comprise:
in response to a search request that specifies a search keyword, creating a search results page that comprises a plurality of identifiers of a plurality of pages, wherein each of the plurality of pages include the search keyword,
selecting a selected advertisement from among a plurality of advertisements that each have respective associated target terms, wherein the selecting chooses the selected advertisement with a largest number of the target terms that match selected words contained in the plurality of pages, wherein at least one of the selected words is different from the search keyword,
embedding the selected advertisement into the search results page, and
sending the search results page to an application that provided the search request.

19. The computer system of claim 18, wherein the selecting further comprises:
calculating a plurality of aggregated weights for the selected words, wherein each of the aggregated weights comprises a sum of a plurality of weights for the respective selected word in the plurality of pages; and
selecting the selected advertisement that has a largest number of associated target terms that match the selected words with largest aggregated weights.

20. The computer system of claim 19, wherein each of the plurality of weights represents a relative importance of the respective selected word in the respective page with respect to other words in the respective page.
